(19) United States
(12) Patent Application Publication
(10) Pub. No.: US 2007/0139451 A1
(43) Pub. Date: Jun. 21, 2007

(54) Microfluidic device having hydrophilic microchannels

(76) Inventors: Nanayakkara L.D. Somasiri, Austin, TX (US); Moses M. David, St. Paul, MN (US)

Correspondence Address: 3M INNOVATIVE PROPERTIES COMPANY, PO BOX 33427, ST. PAUL, MN, 55133-3427, US

(21) Appl. No.: 11/313,885

(22) Filed: Dec. 20, 2005

(51) Int. Cl. B32B 3/10

(52) U.S. Cl. 346/138; 428/137

(57) ABSTRACT

A microfluidic device comprising a multi-layer film having a conductive layer and a polymeric layer disposed adjacent the conductive layer, a microchannel extending through the multi-layer film, where the microchannel has a perimeter surface, and a hydrophilic layer disposed on the perimeter surface of the microchannel. The hydrophilic layer comprises at least about 20% by weight silicon and at least about 40% by weight oxygen.

### BACKGROUND

The present invention relates to microfluidic devices for use in diagnostic applications. In particular, the present invention relates to microfluidic devices having hydrophilic microchannels for use in miniaturized analysis systems.

Diagnostic applications such as medical diagnostics, forensics, genomics, environmental monitoring, and contaminant testing often require routine repetitive testing for detection and identification of chemical compounds. Typically, parallel screening methodologies are used to analyze the large volume of samples in these various fields. Despite improvements in parallel screening methods and other technological advances, such as robotics and high throughput detection systems, current screening methods still have a number of associated problems. For example, screening large numbers of samples using existing parallel screening methods have large space requirements to accommodate the samples and equipment.

Available reaction volumes are often very small due to limited availability of the compound to be identified. Such small volumes can lead to errors associated with fluid handling and measurement (e.g., due to evaporation and dispensing errors). Additionally, fluid-handling equipment and methods are typically unable to handle these small volumes with acceptable accuracy. The shortcomings of standard analysis techniques are promoting development efforts in the area of microfluidic analysis, which involves miniaturized analysis systems, typically referred to as “lab on a chip” systems. These miniaturized analysis systems have many advantages over existing large-scale laboratory equipment, such as portability, small physical sizes, simple operation, and low costs.

Microfluidic devices may be used in miniaturized analysis systems covering a variety of diagnostic applications. For example, microfluidic devices may be used in impedance sensors, which are widely used for counting and characterizing particles and cells. Cell/particle impedance sensors typically include microfluidic devices having electrode-integrated microchannels for measuring impedance perturbations of test fluids flowing through the microchannels. However, microfluidic devices optimized for sensor sensitivity are generally not sufficiently hydrophilic to allow the test fluids to flow through the microchannels and across the electrodes in reasonable test times.

### BRIEF SUMMARY

The present invention relates to a microfluidic device that includes a multi-layer film and a microchannel extending through the multi-layer film, where the microchannel has a perimeter surface. The multi-layer film includes a conductive layer and a polymeric layer disposed adjacent the conductive layer. The microfluidic device also includes a hydrophilic layer disposed on the perimeter surface of the microchannel, where the hydrophilic layer comprises at least about 20% by weight silicon and at least about 40% by weight oxygen. The hydrophilic layer allows for rapid flow rates of test fluids through the microchannel of the microfluidic device.

### BRIEF DESCRIPTION OF THE DRAWINGS

FIG. 1 is a top perspective view of a microfluidic device of the present invention.

FIG. 2 is an expanded view of section 2-2 taken in FIG. 1.

FIG. 3 is a block diagram illustrating a method of forming the microfluidic device of the present invention.

FIG. 4 is a schematic side view of a plasma deposition system suitable for use in forming the microfluidic device of the present invention.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale. Like reference numbers have been used throughout the figures to denote like parts.

### DETAILED DESCRIPTION

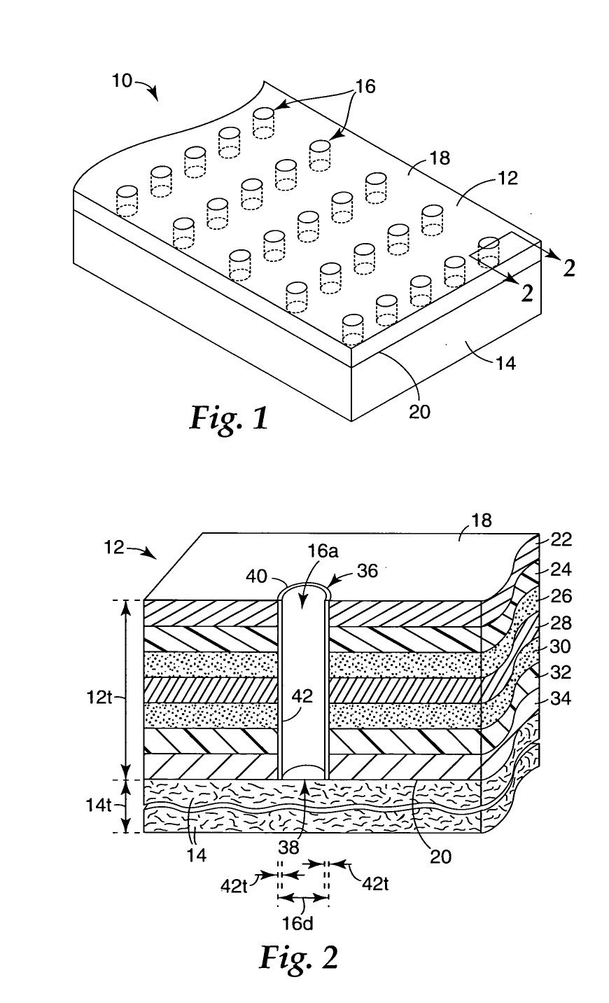

FIG. 1 is a top perspective view of microfluidic device 10 of the present invention, which is suitable for use in a wide variety of miniaturized analysis systems. As shown, microfluidic device 10 includes multi-layer film 12, absorbent layer 14, and a plurality of microchannels 16. Multi-layer film 12 is a film of interlaminated conductive and polymeric layers (not shown in FIG. 1) having top surface 18. Absorbent layer 14 is a fluid-absorbing layer that is laminated to multi-layer film 12 at interface 20. Absorbent layer 14 increases the flow rates of test fluids passing through microchannels 16 through a capillary-wicking action, which reduces the time required to perform test runs.

Microchannels 16 extend through multi-layer film 12 between top surface 18 and interface 20. As discussed below, microchannels 16 are coated with hydrophilic layers that increase the flow rates of test fluids passing through microchannels 16. This also decreases the time required to perform test runs. While microfluidic device 10 is shown with a given number of microchannels 16 in FIG. 1, alternative numbers of microchannels 16 may be used depending on the diagnostic application involved. Examples of suitable numbers of microchannels 16 range from one to about five hundred. The use of multiple microchannels 16 allow numerous samples to be simultaneously tested, thereby further reducing testing durations.

The following discussion of microfluidic device 10 will be made with reference to a portable impedance sensor for counting/characterizing cells or particles contained in a test fluid. However, as discussed above, microfluidic device 10 is suitable for use in a wide variety of miniaturized analysis systems where electrode-integrated microchannels are utilized for fluid manipulations.

FIG. 2 is an expanded view section of 2-2 taken in FIG. 1, which shows one of microchannels 16 (referred to as microchannel 16a) disposed through multi-layer film 12. As shown from top to bottom in FIG. 2, multi-layer film 12 includes conductive layer 22, polymeric layer 24, polymeric adhesive layer 26, conductive layer 28, polymeric adhesive layer 30, polymeric layer 32, and conductive layer 34, which are respectively disposed adjacent each other. The use of the multiple layers allows an application of multiple voltages along microchannel 16a to improve detection of electrical perturbations.

Conductive layers 22, 28, and 34 are layers of conductive material for measuring electrical perturbations of test fluids flowing through microchannel 16a. Accordingly, conductive layers 22, 28, and 34 are desirably connected to one or more external electrodes (not shown) to form circuits for monitoring the electrical perturbations. Examples of suitable materials for conductive layers 22, 28, and 34 include conductive materials, such as copper (Cu), gold (Au), and alloys thereof.

Polymeric layers 24 and 32 are electrically insulating layers, which may or may not increase the flexibility of microfluidic device 10. Examples of suitable materials for polymeric layers 24 and 32 include polyimides, modified polyimides (e.g., polyester imides, poly-imide-esters, polysiloxane imides, and polyamides), polymethylmethacrylates, polyesters, polycarbonates, polytetrafluoroethylenes, polyphenylene sulfides, polyparabanates, polyesters, polyether sulfones, polyethylene naphthalates, polyether ether ketones, liquid crystal polymers, and combinations thereof. Examples of particularly suitable materials for polymeric layers 24 and 32 include polyimides, which have good physical strengths, low dielectric constants, and are chemically resistant.

Polymeric adhesive layers 26 and 30 are tie layers for reducing interlayer delamination of multi-layer film 12. Examples of suitable materials for polymeric adhesive layers 26 and 30 include any adhesive suitable for adhering the polymeric layers (e.g., polymeric layers 24 and 32) to the conductive layers (e.g., conductive layers 22, 28, and 34). Examples of particularly suitable materials for polymeric adhesive layers 26 and 30 include adhesive-functional derivatives of the materials used for polymeric layers 24 and 32 (e.g., polyimide-based adhesives). Additional polymeric adhesive layers may also be used between conductive layer 22 and polymeric layer 24, and between polymeric layer 32 and conductive layer 34.

While the seven-layered film shown in FIG. 2 is a particularly suitable arrangement for multi-layer film 12, multi-layer film 12 may alternatively include other numbers of conductive layers, polymeric layers, and polymeric adhesive layers. Minimally, multi-layer film 12 desirably includes at least one conductive layer and at least one polymeric layer. Examples of overall layer thicknesses 12t for multi-layer film 12 range from about 50 micrometers to about 500 micrometers, with particularly suitable overall thicknesses 12t ranging from about 100 micrometers to about 300 micrometers. Examples of suitable layer thicknesses for each layer of multi-layer film 12 (e.g., each of conductive layers 22, 28, and 34, polymeric layers 24 and 32, and polymeric adhesive layers 26 and 30) range from about 10 micrometers to about 70 micrometers.

Absorbent layer 14 is secured to conductive layer 34, beneath microchannel 16a. This allows absorbent layer 14 to absorb test fluids that flow through microchannel 16a. Examples of suitable materials for absorbent layer 14 include one or more low-swelling or non-swelling, hydrophilic absorbent materials, such as porous non-woven materials. An example of a suitable material for absorbent layer 14 includes a non-woven pad compositionally comprising 80% cellulose (Rayon) and 20% super-absorbent polyacrylates (Oasis Fiber), which is commercially available under the trade designation “TMED92” from National Nonwovens, Easthampton, Mass.

Absorbent layer 14 desirably has a thickness 14t that provides a sufficient volume of hydrophilic absorbent material to absorb the test fluids that flow from microchannels 16 without flooding absorbent layer 14. Flooding may undesirably prevent absorbent layer 14 from wicking the test fluids from microchannels 16. Examples of suitable layer thicknesses 14t for absorbent layer 14 range from about 500 micrometers to about 1,000 micrometers.

Microchannel 16a includes entrance 36, exit 38, and perimeter surface 40, where perimeter surface 40 is an annular surface defined by multi-layer film 12 between entrance 36 and exit 38. Perimeter surface 40 may alternatively have other geometric configurations (e.g., square). Entrance 36 is a first orifice of microchannel 16a adjacent top surface 18 of multi-layer film 12 where test fluid is introduced into microchannel 16a. Correspondingly, exit 38 is a second orifice of microchannel 16a adjacent interface 20, through which the test fluid exits microchannel 16a into absorbent layer 14. Microchannel 16a desirably extends substantially perpendicular to the layers of multi-layer channel 12, where substantially perpendicular is defined herein as an angle to the layer ranging from about 85° to about 95° (microchannel 16a is shown extending perpendicular to the layers of multi-layer channel 12 in FIG. 2).

Microchannel 16a has a diameter measured from opposing locations on the outside of perimeter surface 40 (referred to as diameter 16d). To optimize impedance-sensor sensitivity, diameter 16d is desirably specified to be less than an order of magnitude larger than the particle sizes of interest. For example, when microfluidic device 10 is used in impedance sensors for counting/characterizing blood cells, suitable diameters 16d of microchannel 16a may range from about 50 micrometers to about 100 micrometers (white blood cells are typically about 10-12 micrometers in size, and red blood cells and platelets are somewhat smaller). The length of microchannel 16a, which is the same as thickness 12t of multi-layer film 12, may depend on several factors, such as the number of incorporated conductive layers (e.g., conductive layers 22, 28, and 34), the layer thicknesses of the conductive layers, the spacing of the conductive layers, and manufacturability issues. Examples of suitable aspect ratios of the length of microchannel 16a (i.e., thickness 12t of micro-layer film 12) to diameter 16d of microchannel 16a range from about 2:1 to about 5:1.

As further shown in FIG. 2, perimeter surface 40 of microchannel 16a is coated with hydrophilic layer 42. Hydrophilic layer 42 is a layer that includes one or more silicon-containing materials, such as silicon/oxygen-based materials, diamond-like glass (DLG) materials, and combinations thereof. DLG materials are amorphous carbon materials that include a substantial quantity of silicon and oxygen (similar to glass), yet still retain diamond-like properties. Examples of suitable DLG materials are disclosed in David et al., U.S. Pat. No. 6,696,157 and Haddad et al., U.S. Pat. No. 6,881,538, both of which are commonly assigned. The silicon-containing materials of hydrophilic layer 42 facilitate wetting of perimeter surface 40 and enhance flow of the test fluids that pass through microchannel 16a. Examples of suitable layer thicknesses 42t for hydrophilic layer 42 range from about 0.5 nanometers to about 10.0 nanometers, with particularly suitable layer thicknesses 42t ranging from about 1.0 nanometer to about 5.0 nanometers.

Examples of suitable component concentrations for the silicon-containing materials include at least about 20% by weight silicon and at least about 40% by weight oxygen. Additional examples of suitable component concentrations for the silicon-containing materials include about 50% by weight or less silicon, about 80% or less oxygen, and about 10% or less carbon. Examples of particularly suitable component concentrations (by weight) for the silicon-containing materials include about 25% to about 35% silicon, about 55% to about 70% oxygen, and about 5% to about 8% carbon. Component concentrations of the silicon-containing materials in hydrophilic layer 42 may be quantitatively determined using a variety of standard analytical techniques, such as XPS analysis.

When microfluidic device 10 is used in an impedance sensor, one or more of conductive layers 22, 28, and 34 of multi-layer film 12 may be connected to external electrodes (not shown) for detecting electrical perturbations through microchannel 16a. When performing an impedance experiment, test fluids containing cells or particles may be introduced into microchannel 16a through entrance 36. Electrical currents are then passed through the test fluid from conductive layers 22, 28, and 34. As the cells/particles pass through microchannel 16a, the flow of electrical currents are perturbed. The characteristics of these perturbations in the electrical currents provide information about, e.g., the size of the cells/particles.

In general, the strength of the electrical perturbation due to the presence of a cell/particle in microchannel 16a depends on the ratio of the cell/particle volume to the volume of microchannel 16a and the magnitude of the electrical current passing in the channel. The volume of microchannel 16a may be determined from the length of microchannel 16a and diameter 16d. The concentration of cells/particles in a given test fluid may then be determined by counting the electrical perturbations that occur when a metered volume of test fluid is drawn through the microchannel 16a, and then dividing the count by the volume of microchannel 16a.

As discussed above, hydrophilic surface 42 enhances the flow rate of the test fluid passing through microchannel 16a. Accordingly, while the test fluid flows through microchannel 16a, hydrophilic surface 42 reduces the frictional resistance of the flow at perimeter surface 40 of microchannel 16a. As a result, the test fluid passes through microchannel 16a at an increased rate, thereby reducing the time required to perform an impendence experiment. Additionally, absorbent layer 14 wicks test fluid through exit 38 of microchannel 16a through a capillary action, further reducing experiment times.

The combination of hydrophilic surface 42 and absorbent layer 14 increases the flow rate of the test fluid through microchannel 16a, which allows microchannel 16a to attain high aspect ratios (e.g., length-to-diameter ratios greater than about 2:1) while also providing increased flow rates of the test fluids. As such, microfluidic device 10 is beneficial for use with a wide variety of miniaturized analysis systems that utilize fluid manipulations.

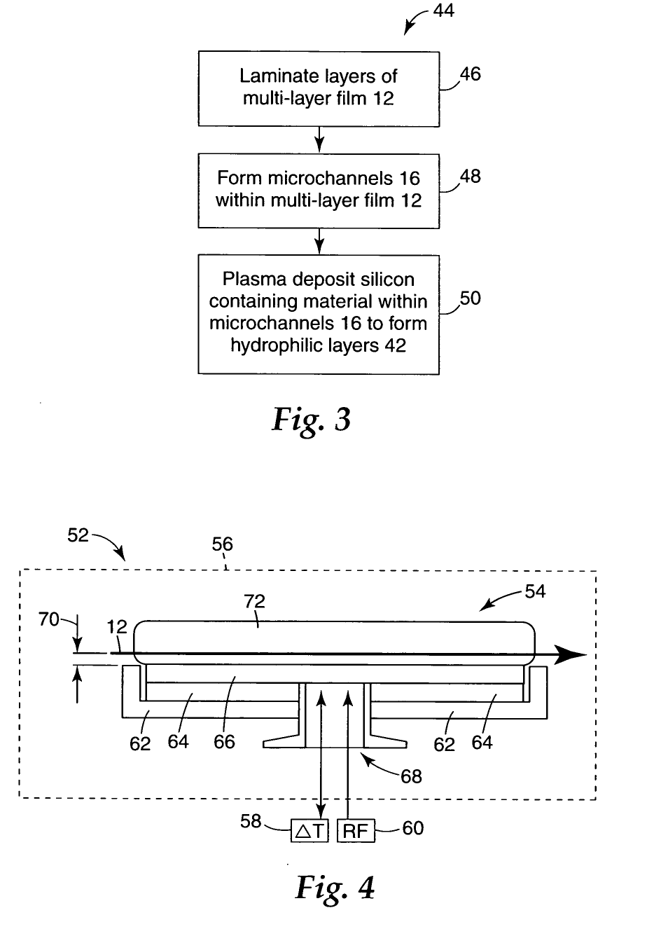

FIG. 3 is a block diagram illustrating a suitable method for forming microfluidic device 10 (referred to as method 44). As shown, method 44 initially involves laminating conductive and polymeric layers to form multi-layer film 12, which may be performed in a variety of manners (step 46). For example, conductive layers 22 and 34 may be respectively deposited on polymeric layers 24 and 32. This provides a pair of conductive/polymeric films, which may then be adhered to conductive layer 28 with polymeric adhesive layers 26 and 30 to form a seven-layer film. Conductive layers 22 and 34 (the surface layers) may also be further plated and/or flash plated with the above-discussed conductive materials.

After multi-layer film 12 is formed, microchannels 16 (e.g., microchannel 16a) may then be formed within multi-layer film 12 with precision cutting or drilling techniques (step 48). For example, microchannels 16 may be laser-ablated into multi-layer film 12 with a yttrium-aluminum-garnet (YAG) laser system (e.g., a Neodymium(Nd):YAG laser system). The diameters of microchannels 16 (e.g., diameter 16d) may vary depending on the focal width and intensity of the laser system.

Hydrophilic layer 42 may then be deposited on perimeter surface 40 within microchannel 16a by plasma deposition, which may occur in a batch-wise process or a continuous process (step 50). The following discussion will continue to refer to microchannel 16a with the understanding that the plasma deposition occurs in a substantially simultaneous manner within all of microchannels 16. As used herein, the term “plasma” means a partially ionized gaseous or fluid state of matter containing reactive species which include electrons, ions, neutral molecules, free radicals, and other excited state atoms and molecules. Visible light and other radiation are typically emitted from the plasma as the species forming the plasma relax from various excited states to lower, or ground, states. The plasma usually appears as a colored cloud in a reaction chamber.

In general, plasma deposition involves moving multi-layer film 12 through a chamber filled with one or more gaseous silicon-containing compounds at a reduced pressure (relative to atmospheric pressure). Conductive layers 22 and 34 (the surfaces of multi-layer film 12) may be masked to confine the plasma deposition to perimeter surface 40 of microchannel 16a. Power is provided to an electrode located adjacent to, or in contact with multi-layer film 12. This creates an electric field, which forms a silicon-rich plasma from the gaseous silicon-containing compounds.

Ionized molecules from the plasma then accelerate toward the electrode and impact on perimeter surface 40 within microchannel 16a (and also on the masked surfaces of multi-layer film 12). By virtue of this impact, the ionized molecules react with, and covalently bond to, perimeter surface 40. This forms hydrophilic layer 42 on perimeter surfaces 40. One benefit of plasma deposition is that the temperatures required for depositing hydrophilic layer 42 are relatively low (e.g., about 10° C.). This is beneficial because high temperatures required for alternative deposition techniques (e.g., chemical vapor deposition) are known to degrade many materials suitable for multi-layer film 12, such as polyimides.

The extent of the plasma deposition may depend on a variety of processing factors, such as the composition of the gaseous silicon-containing compounds, the presence of other gases, the exposure time of perimeter surface 40 to the plasma, the level of power provided to the electrode, the gas flow rates, and the reaction chamber pressure. These factors correspondingly help determine a layer thickness 42t of hydrophilic layer 42, as shown in FIG. 2.

FIG. 4 is schematic side view of plasma deposition system 52, which is a suitable system for plasma depositing hydrophilic layers 42 on perimeter surfaces 40. Examples of suitable systems for plasma deposition system 52 are disclosed in David et al., U.S. Pat. Nos. 6,696,157 and 6,749,813, and in Cronk et al., U.S. Pat. No. 6,795,636, all of which are commonly assigned. An example of a suitable commercially available system for plasma deposition system 52 includes trade designated “MODEL 2480” plasma reactor, which is available from PlasmaTherm, St. Petersburg, Fla.

As shown in FIG. 4, system 52 includes planar electrode 54, reaction chamber 56, temperature control system 58, and power source 60. Planar electrode 54 includes backing plate 62, insulating layer 64, and conductive plate 66, where backing plate 62 and insulating layer 64 electrically insulate conductive plate 66. Planar electrode 54 also includes conduit 68 for supplying coolant fluid from temperature control system 58 and power from power source 60.

Temperature control system 58 may heat or cool the planar electrode 54 as necessary to provide planar electrode 54 with an appropriate temperature that supports plasma deposition. Temperature control system 58 is desirably a coolant system using a coolant fluid, such as water, ethylene glycol, chlorofluorocarbons, hydrofluoroethers, liquefied gases (e.g., liquid nitrogen), and combinations thereof. Temperature control system 58 desirably pumps the coolant fluid through planar electrode 54 throughout the duration of the plasma deposition process to selectively control the temperature of planar electrode 54. Suitable temperatures for planar electrode 54 range from about 5° C. to about 20° C.

Power source 60 may be any power generation or transmission system capable of supplying sufficient power to planar electrode 54. An example of a suitable power source 60 includes a radio frequency (RF) power source for supplying RF power. RF power exhibits a frequency that is high enough to form a negative bias on an appropriately configured version of planar electrode 54, but not high enough to create standing waves in the resulting plasma. Standing waves generally decrease plasma deposition efficiency. RF power is scalable for high coating output (e.g., wide films and rapid line speeds). When RF power is used, the negative bias on planar electrode 54 is a negative self bias (i.e., no separate power source needs to be used to induce the negative bias on planar electrode 54).

Power source 60, as an RF power source, may power planar electrode 54 with frequencies ranging from about 0.01 to about 50 MHz, preferably 13.56 MHz or any whole number (e.g., 1, 2, or 3) multiple thereof. This RF power, as supplied to planar electrode 54, creates a silicon-rich plasma from the gaseous silicon-containing compounds. A suitable RF example of power source 60 includes an RF generator, such as a 13.56 MHz oscillator connected to planar electrode 54 via a network that functions to match the impedance of the power supply with that of the transmission line (which is usually 50 ohms resistive) and thereby effectively transmits RF power through a coaxial transmission line.

During operation, and prior to plasma deposition, reaction chamber 56 may be evacuated to remove air, such as by means of vacuum pumps (not shown) connected to reaction chamber 56. After the air is purged from reaction chamber 56, gaseous silicon-containing compounds may then be introduced into reaction chamber 56 at a desired flow rate. The desired flow rate may depend on several factors, such as the size of reaction chamber 56, the number of microchannels 16, and the surface area of perimeter surface 40 that will receive the deposited ions. Such flow rates are desirably sufficient to establish a suitable pressure, which typically ranges from about 1.0×10⁻⁶ Torr to about 1.0 Torr, for accomplishing the plasma deposition.

As discussed above, hydrophilic layer 42 may include one or more silicon-containing materials, such as silicon/oxygen materials, diamond-like glass (DLG) materials, and combinations thereof. Examples of suitable gaseous silicon-containing compounds for depositing layers of silicon/oxygen materials include silanes (e.g., SiH₄). Examples of suitable gaseous silicon-containing compounds for depositing layers of DLG materials include gaseous organosilicon compounds that are in a gaseous state at the reduced pressures of reaction chamber 56. Examples of suitable organosilicon compounds include trimethylsilane, triethylsilane, trimethoxysilane, triethoxysilane, tetramethylsilane, tetraethylsilane, tetramethoxysilane, tetraethoxysilane, hexamethylcyclotrisiloxane, tetramethylcyclotetrasiloxane, tetraethylcyclotetrasiloxane, octamethylcyclotetrasiloxane, hexamethyldisiloxane, bistrimethylsilylmethane, and combinations thereof. An example of a particularly suitable organosilicon compound includes tetramethylsilane.

In addition to the gaseous silicon-containing compounds, one or more gaseous non-organic compounds may also be introduced into reaction chamber 56 to assist the plasma deposition. Examples of suitable gaseous non-organic compounds include argon, hydrogen, nitrogen, helium, ammonia, and combinations thereof. The flow rate of the gaseous non-organic compounds may vary depending on the desired ratio of gaseous non-organic compounds to gaseous silicon-containing compounds. However, the total flow rates of the gaseous non-organic compounds and the gaseous silicon-containing compounds are desirably sufficient to establish a suitable pressure (e.g., from about 1.0×10⁻⁶ Torr to about 1.0 Torr) for accomplishing the plasma deposition.

Examples of suitable volumetric flow ratios of the gaseous non-organic compounds to the gaseous silicon-containing compounds range from about 0:1 (i.e., no gaseous non-organic compounds) to about 15:1. The gaseous silicon-containing compounds and the gaseous non-organic compounds may be introduced to reaction chamber 56 as a single premixed gas, or alternatively, as separate gases that substantially mix with each other within reaction chamber 56. After completing a plasma deposition process with gaseous silicon-containing compounds, gaseous non-organic compounds may continue to be used for plasma treatment to remove surface methyl groups from the deposited materials. This increases the hydrophilic properties of the resulting hydrophilic layer 42.

During formation of microfluidic device 10, multi-layer film 12 may be fed across conductive plate 66 of planar electrode 54, where multi-layer film 12 is disposed above the conductive plate 52 by separation distance 70. Examples of suitable separation distances 70 between multi-layer film 12 and conductive plate 66 range from about 2.5 millimeters to about 13 millimeters. Separation distance 70 provides a non-contact arrangement between multi-layer film 12 and conductive plate 66. Because of the planar nature and non-contact arrangement, planar electrode 54 is suitable for forming multi-layer film 12 with a continuous process. Alternatively, multi-layer film 12 may contact conductive plate 66 as multi-layer film 12 is fed past planar electrode 54.

Upon application of RF power to conductive plate 66, ion sheath 72 is formed, which causes conductive plate 66 to become negatively self biased relative to the plasma. The term “negative bias” means that an object (e.g., an electrode) has a negative electric potential with respect to some other matter (e.g., a plasma) in the vicinity of the object. Similarly, the term “negative self bias”, with respect to an electrode and a plasma, means a negative bias developed by application of power to the electrode that creates a plasma. The use of ion sheath 72 is desirable to obtain and support ion bombardment, which, in turn, is desirable to produce a densely packed hydrophilic layer 42 on perimeter surface 40. The negative bias is generally in the range of 500 to 1400 volts, and causes the gaseous silicon-containing compounds to become ionized, resulting in the formation of a silicon-rich plasma with ions therein.

Once the plasma has been created, a negative DC bias voltage is created on conductive plate 66 by continuously powering conductive plate 66 with RF power from power source 60. This negative DC bias causes ions within the silicon-rich plasma to accelerate toward the conductive plate 66. Accordingly, the ions bombard perimeter surface 40 within microchannel 16a (and the masked top surface 18 of multi-layer film 12), which are disposed above conductive plate 66. This causes the silicon-containing compounds to covalently bond to perimeter surface 40, thereby forming hydrophilic layer 42 on at least a portion of perimeter surface 40.

After passing through planar electrode 54, multi-layer film 12 may be repositioned upside-down and re-passed through planar electrode 54 to plasma deposit silicon-containing compounds from the opposing side of multi-layer film 12. This increases the coverage of hydrophilic layer 42 over perimeter surface 40.

Overall, the above-discussion of plasma generation and ion acceleration with planar electrode 54 is greatly simplified. Only one electrode is used rather than a source electrode and a target electrode. The powered electrode both creates the plasma and becomes negatively self biased, thereby accelerating ions within the plasma toward the powered electrode for bombardment of multi-layer film 12. This DC biasing voltage also serves to densify the deposited coating, which enhances the properties of the hydrophilic layer 42.

After hydrophilic layer 42 is deposited on perimeter surface 40, absorbent layer 14 may be laminated to multi-layer film 12, adjacent exit 38 of each microchannel 16. The resulting microfluidic device 10 may then be connected to an impedance sensor or other miniaturized analysis systems. The use of plasma-deposited hydrophilic layer 42 and absorbent layer 14 increases the flow rate of test fluids passing through microchannels 16, thereby reducing the time required to perform tests.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

The following compositional abbreviations are used in the following Examples:
“Polyimide”: A polyimide film commercially available under the trade designation “KAPTON E” polyimide film from E. I. DuPont de Nemours Co., Wilmington, Del.
“Polyimide adhesive”: A polyimide-based adhesive available from Sigma-Aldrich Chemical Company, Saint Louis, Mo.
“TMS”: NMR-grade Tetramethylsilane gas (Si(CH₃)₄) commercially available from Sigma-Aldrich Chemical Company, Saint Louis, Mo.
“Silane”: Silane gas (SiH₄) commercially available from Sigma-Aldrich Chemical Company, Saint Louis, Mo.
“Oxygen”: Ultra-pure oxygen gas (O₂) commercially available from Sigma-Aldrich Chemical Company, Saint Louis, Mo.
“Argon”: Ultra-pure argon gas (Ar) commercially available from Sigma-Aldrich Chemical Company, Saint Louis, Mo.
“Non-woven pad”: A non-woven pad compositionally comprising 80% cellulose (Rayon) and 20% super-absorbent polyacrylates (Oasis Fiber), commercially available under the trade designation “TMED92” from National Nonwovens, Easthampton, Mass.

### Example 1

The microfluidic device of Example 1 included a DLG-based hydrophilic layer without the use of an absorbent layer. The microfluidic device was formed by the following procedure. A pair of single-clad copper/polyimide films were laminated to a single one-ounce copper core sheet with the use of polyimide adhesive films. The resulting multi-layer film resembled the seven-layer film arrangement shown in FIG. 2. Each of the single-clad copper/polyimide films had a copper layer thickness of 18 micrometers and a polyimide layer thickness of 25 micrometers. The copper core sheet and the polyimide adhesive films each had layer thicknesses of 35 micrometers. The two outer copper layers were then plated with copper up to 25 micrometers and then flash plated with 5 micrometers of gold. The layer thickness of the overall multi-layer film was about 200 micrometers, and the surface areas of the top and bottom surfaces of the multi-layer film were 16.7 millimeters×16.7 millimeters (taken in a plane perpendicular to the layer thickness).

A 20×20 array of microchannels was then laser ablated through the multi-layer film with an Nd:YAG laser. This resulted in 400 microchannels extending perpendicularly through the layers of the multi-layer film, where the microchannels had varying hole diameters ranging from 40 micrometers to 100 micrometers (i.e., length-to-diameter aspect ratios ranging from 5:1 to 2:1, respectively).

The multi-layer film was then passed through a plasma-deposition system to deposit hydrophilic layers of DLG materials within the microchannels. The plasma-deposition system was a trade designated “MODEL 2480” plasma reactor, commercially available from PlasmaTherm, St. Petersburg, Fla. Prior to the plasma deposition, the reaction chamber was purged of air. TMS and oxygen were then pumped into the system at respective flow rates of 150 standard-cubic centimeters/minute (sccm) and 500 sccm, which provided a pressure of 52 milliTorr.

RF power of 1,500 watts was applied to the conductive plate of the plasma-deposition system, which caused the contained gases to become ionized, resulting in the formation of a silicon-rich plasma with ions therein. The multi-layer film was exposed to the plasma for a treatment time of ten seconds. During this time, ions from the plasma bombarded the microchannels, causing the TMS to covalently bond to the perimeter surfaces of the microchannels. This resulted in hydrophilic layers being formed in the microchannels, where the hydrophilic layers compositionally included DLG materials.

After the ten-second interval, the flow of TMS was stopped (the flow of oxygen was maintained at 500 sccm) and the pressure was controlled at 150 milliTorr. The RF power was reduced to 300 watts and the multi-layer film was then subjected to the resulting oxygen plasma for 60 seconds to remove any surface methyl groups from the deposited hydrophilic layers. The resulting multi-layer film was then repositioned upside-down and the above-described plasma deposition process was repeated to ensure adequate coatings of the hydrophilic layers within the microchannels. After the second plasma deposition process was completed, the resulting microfluidic device of Example 1 was tested for fluid flow properties, as discussed below.

### Example 2

The microfluidic device of Example 2 included the microfluidic device of Example 1, where a non-woven pad was laminated to the microfluidic device to function as an absorbent layer.

### Example 3

The microfluidic device of Example 3 was formed by the same procedure as discussed above for the microfluidic device of Example 1, except that the TMS flow rate was 50 sccm, the pressure was 50 milliTorr, and the treatment time of the multi-layer film in the TMS/O₂ plasma was five seconds. After the plasma deposition process, a non-woven pad was laminated to the microfluidic device to function as an absorbent layer.

### Example 4

The microfluidic device of Example 4 included a silicon/oxygen-based hydrophilic layer with the use of an absorbent layer. The multi-layer film and microchannels of the microfluidic device of Example 4 were formed by the same procedure as discussed above for the microfluidic device of Example 1. However, the plasma deposition process was performed by the following procedure.

The multi-layer film was passed through a plasma-deposition system to deposit hydrophilic layers of silicon/oxygen materials within the microchannels. The plasma-deposition system was a trade designated “MODEL 2480” plasma reactor, commercially available from PlasmaTherm, St. Petersburg, Fla. Prior to the plasma deposition, the reaction chamber was purged of air. A mixture of 2% (by volume) silane in argon was pumped into the reaction chamber at a flow rate of 2,000 sccm. Simultaneously, oxygen was pumped into the reaction chamber also at a flow rate of 2,000 sccm. The resulting pressure was 990 milliTorr.

RF power of 1,000 watts was applied to the conductive plate of the plasma-deposition system, which caused the contained gases to become ionized, resulting in the formation of a silicon-rich plasma with ions therein. The multi-layer film was exposed to the plasma for a treatment time of 120 seconds. During this time, ions from the plasma bombarded the microchannels, causing the silane to covalently bond to the perimeter surfaces of the microchannels. This resulted in hydrophilic layers being formed in the microchannels, where the hydrophilic layers compositionally included silicon/oxygen materials. Because the silane did not contain any methyl groups, post-oxygen plasma treatment was not required. After the plasma deposition process, a non-woven pad was laminated to the microfluidic device to function as an absorbent layer. The resulting microfluidic device of Example 4 was then tested for fluid flow properties, as discussed below.

### Comparative Example A

The microfluidic device of Comparative Example A included a multi-layer film that was not plasma treated, and an absorbent layer. The multi-layer film and microchannels of the microfluidic device of Comparative Example A were formed by the same procedure as discussed above for the microfluidic device of Example 1. A non-woven pad was then laminated to the microfluidic device to function as an absorbent layer.

Fluid Flow Testing for Examples 1-4 and Comparative Example A

Fluid flow rates of test fluids were quantitatively measured for each of the microfluidic devices of Examples 1-4 and Comparative Example A pursuant to the following procedure. A hollow plastic tube was sealed with silicone grease to the top surface of the microfluidic device, thereby encircling the entrances of all 400 microchannels. Two milliliters of a saline solution (0.5 molar sodium chloride, pH 7) was syringed into the hollow plastic tube and the total time for the entire saline to flow through the microchannels was measured. Table 1 provides the fluid flow rates of the saline solutions for the microfluidic devices of Examples 1-4 and Comparative Example A.

TABLE 1

| | | | Fluid Flow |
|---|---|---|---|
| | | | Rate (milli- |
| Example | Plasma Type | Absorbent Layer | liters/second) |
| Example 1 | TMS/O2 | None | 0.33 |
| | (10 seconds) | | |
| Example 2 | TMS/O2 | Non-woven pad | 0.50 |
| | (10 seconds) | | |
| Example 3 | TMS/O2 | Non-woven pad | 0.30 |
| | (5 seconds) | | |
| Example 4 | SiH₄/O₂ | Non-woven pad | 0.16 |
| | (120 seconds) | | |
| Comparative | N/A | Non-woven pad | 3.70 × 10⁻⁴ |
| Example A | | | |

The data in Table 1 shows the increased hydrophilic properties obtained with the use of the hydrophilic layers and with the use of the absorbent layers. In comparing the microfluidic devices of Examples 2 and 3 with the microfluidic device of Comparative Example A, the use of the DLG-based hydrophilic layer increased the flow rates of the test fluids by over 1300 times and 800 times, respectively. This substantial increase in hydrophilic properties correspondingly decreases the time required to perform experiments.

Similarly, in comparing the microfluidic device of Example 4 with the microfluidic device of Comparative Example A, the use of the silane-based hydrophilic layer increased the flow rates of the test fluids by over 400 times. Moreover, in comparing the microfluidic devices of Examples 1 and 2, the use of the absorbent layer increased the flow rates of the test fluids by 50%. Accordingly, the use of the hydrophilic layers and the absorbent layers provides hydrophilic microchannels with significantly enhanced fluid flow rates. Therefore, the microfluidic devices of the present invention are suitable for use in a wide variety of miniaturized analysis systems where electrode-integrated microchannels are utilized for fluid manipulations (e.g., portable impedance sensors).

Although the present invention has been described with reference to preferred embodiments, workers skilled in the art will recognize that changes may be made in form and detail without departing from the spirit and scope of the invention.

1. A microfluidic device comprising:
a multi-layer film comprising a conductive layer and a polymeric layer disposed adjacent the conductive layer;
a microchannel extending through the multi-layer film, the microchannel having a perimeter surface; and
a hydrophilic layer disposed on the perimeter surface of the microchannel, the hydrophilic layer comprising at least about 20% by weight silicon and at least about 40% by weight oxygen.

2. The microfluidic device of claim 1, wherein the multi-layer film comprises a plurality of conductive layers and a plurality of polymeric layers.

3. The microfluidic device of claim 1, wherein the polymeric layer comprises polyimide.

4. The microfluidic device of claim 1, wherein the microchannel has a length-to-diameter aspect ratio greater than 2:1.

5. The microfluidic device of claim 1, wherein the hydrophilic coating comprises a diamond-like glass material.

6. The microfluidic device of claim 5, wherein the diamond-like glass material comprises less than about 10% by weight carbon.

7. The microfluidic device of claim 1, wherein the microchannel further has an entrance and an exit, and wherein the microfluidic device further comprises an absorbent layer disposed adjacent the exit of the microchannel.

8. The microfluidic device of claim 7, wherein the absorbent layer comprises a porous non-woven material.

9. A microfluidic device comprising:
a film comprising a conductive layer;
a microchannel extending through the film, the microchannel having an entrance, an exit, and a perimeter surface disposed between the entrance and the exit;
a hydrophilic layer disposed on the perimeter surface of the microchannel, the hydrophilic layer comprising at least about 20% by weight silicon and at least about 40% by weight oxygen; and
an absorbent material disposed adjacent the exit of the microchannel.

10. The microfluidic device of claim 9, wherein the film further comprises a polymeric layer disposed adjacent to the conductive layer.

11. The microfluidic device of claim 10, wherein the microchannel extends in a direction substantially perpendicular to the conductive layer and the polymeric layer.

12. The microfluidic device of claim 9, wherein the hydrophilic layer comprises a diamond-like glass material.

13. The microfluidic device of claim 12, wherein the diamond-like glass material comprises less than about 10% by weight carbon.

14. The microfluidic device of claim 9, wherein the absorbent material comprises a porous non-woven material.

15. A method of forming a microfluidic device, the method comprising:
forming a microchannel within a multi-layer film, the microchannel having an entrance, an exit, and a surface disposed between the entrance and the exit, wherein the multi-layer film comprises a conductive layer and a polymeric layer disposed adjacent the conductive layer; and
plasma depositing a silicon-based material on the surface of the microchannel to form a hydrophilic layer comprising at least about 20% by weight silicon and at least about 40% by weight oxygen.

16. The method of claim 15, further comprising interlaminating a plurality of conductive layers and a plurality of polymeric layers to form the multi-layer film.

17. The method of claim 15, wherein forming the microchannel comprises laser ablating the multi-layer film.

18. The method of claim 15, wherein the hydrophilic layer comprises a diamond-like glass material.

19. The method of claim 15, wherein the silicon-based material comprises tetramethylsilane.

20. The method of claim 15, further comprising securing an absorbent material adjacent the exit of the microchannel.
